(19) United States
(12) Patent Application Publication
(10) Pub. No.: US 2008/0045249 A1
(43) Pub. Date: Feb. 21, 2008

(54) Mobile terminal and method for sending short text message on mobile terminal

(75) Inventor: Ki Yong Nam, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/713,532

(22) Filed: Mar. 2, 2007

(30) Foreign Application Priority Data
Aug. 17, 2006 (KR) 2006-0077472

(51) Int. Cl. H04Q 7/20

(52) U.S. Cl. 455/466

(57) ABSTRACT

Provided are a mobile terminal and a method for sending a short message on the mobile terminal. The method for sending the short message includes setting original and correct character strings required in an address book, each correct character string corresponding to recipients; inputting one short message for the recipients containing an original character string; replacing the original character string in the short message with the correct character strings to generate corrected short messages, each corrected short message corresponding to the recipients; and sending corrected short messages to the corresponding recipients. The method allows a caller to send a corrected short message to each recipient by correcting one short message according to the recipient's attributes. For group transmission to a plurality of recipients, the method enables a caller to write only one original short message that, before transmission, may be corrected to satisfy different attributes of the recipients.

### PRIORITY

This application claims priority to an application filed in the Korean Intellectual Property Office on Aug. 17, 2006 and assigned Serial No. 2006-0077472, the contents of which are incorporated herein by reference.

### BACKGROUND OF THE INVENTION

1. Field of the Invention

The present invention relates to a mobile terminal and a method for processing a message, and more particularly, to a mobile terminal that allows a caller to send corrected short messages to recipients by correcting, according to different attributes of the recipients, one original short message input by the caller, and a method for sending a short message from the mobile terminal.

2. Description of the Related Art

With advancement of mobile communication technologies, a mobile terminal has allowed voice calling through a mobile terminal without temporal or spatial restrictions. Mobile terminals have evolved to provide users with various functions for text information, image information, MP3 files, and games that are displayed on a screen.

As usage of mobile terminals increases, the use of Short Message Service (SMS) has become more widespread. SMS is a service that allows a caller to economically send a text message regardless of the operation state of a recipient's terminal.

In particular, a short message can be sent to a single user (“single transmission”) or a group of users (“group transmission”). A “caller” hereinafter refers to a user of a mobile terminal that sends a short message and a “recipient” refers to a user of a terminal to which a short message is sent.

The caller determines attributes of a recipient according to factors of the recipient such as age, job title, group, or relationship to the caller. Therefore, a short mobile phone text message in common terms or informal language from a caller which seems proper for the caller's contemporary recipients may irritate his or her senior recipients.

When intended recipients of a group transmission have the same attributes, the caller may easily compose a short message to suit all intended recipients. However, it is difficult for a caller to write a short message for a group transmission wherein the recipients have different attributes. For a short message be simultaneously acceptable to all recipients with different attributes, the short message may often become overly formal and dull for recipients to read, and too tiresome for caller to write.

### SUMMARY OF THE INVENTION

In order to solve the above problems, an object of the present invention is to provide a mobile terminal and a method for a mobile terminal to correct one original message input by a caller to satisfy different attributes of multiple recipients in a group transmission before transmission of the message.

In order to achieve the above object, according to the present invention, there is provided a method for sending a short message on a mobile terminal to multiple recipients, including inputting original and correct character strings in an address book, each string corresponding to different attributes of each of intended recipients; inputting one short message for the recipients containing original character string; replacing, for each recipient, original character string in the short message with the correct character string corresponding to that recipient to generate a corrected short message for that recipient; and sending the corrected short messages to the corresponding recipients.

Preferably, in the step of setting original and correct character string for each recipient, the original and correct character string is set according to attributes of the recipient.

Preferably, the step of setting original and correct character string for each recipient includes selecting address information of the recipient that has the recipient's attributes from the address book; setting the original and correct character string suitable for the recipient's attributes; and adding the original and correct character string to the recipient's address information. Preferably, the recipient's attributes include the recipient's age, job title, group, or relationship to the caller.

Preferably, original character string in the original short message includes a flag appellation and a flag predicate ending. The correct character string for each recipient includes a correct appellation and a correct predicate ending composed according to certain attributes of the recipient. The original and correct character string may be set by selecting from correction character string data or by inputting directly from the caller.

Preferably, the step of replacing the original character string with the correct character string to generate a corrected short message for each recipient includes detecting the original character string from the original short message; and replacing the original character string with the correct character string to generate a corrected short message for each recipient.

Preferably, the step of setting original and correct character string for each recipient in an address book includes selecting an address book menu; selecting address information of the recipient containing the recipient's attributes from the address book menu; displaying correction character string data; selecting original and correct character strings from the correction character string data; and adding the selected original and correct character strings to the recipient's address information.

According to another embodiment of the present invention, there is provided a mobile terminal including a memory unit for storing an address book containing original and correct character strings set according to recipients' attributes; a key input unit for inputting a short message for the recipients containing the original character string; a correction character string detector for detecting the original character string from the short message; a character string corrector for correcting the short message by, for each recipient, replacing the original character string with the correct character string corresponding to that recipient to generate a corrected short message; and a wireless communication unit for receiving corrected short messages from the character string corrector and sending the corrected short messages to the corresponding recipients.

Preferably, the mobile terminal further includes a correction character string setter for setting the original and correct character strings through a key input by the key input unit and adding the set original and correct character strings to the address book stored in the memory unit.

Preferably, the address book includes for each intended recipient at least one entry representing the recipient's address information that has one or more of the recipient's attributes such as the recipient's name, phone number, and correct character strings.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a configuration of a mobile terminal according to the present invention;

FIG. 2 is a diagram illustrating an example of correction character string data stored in a memory unit of FIG. 1;

FIG. 3 is a diagram illustrating an example of an address book stored in the memory unit of FIG. 1;

FIG. 4 is a flowchart illustrating a method for sending a short message on a mobile terminal according to the present invention;

FIG. 5 is a detailed flowchart illustrating a step of setting original and correct character strings in the method illustrated in FIG. 4;

FIG. 6 is a detailed flowchart illustrating steps of inputting a short message and sending a corrected short message in the method illustrated in FIG. 4; and

FIG. 7 is a diagram illustrating an example of a method for sending a short message on a mobile terminal according to the present invention.

### DETAILED DESCRIPTION OF PREFERRED EMBODIMENTS

Hereinafter, preferred embodiments of the present invention are described in detail with reference to the accompanying drawings.

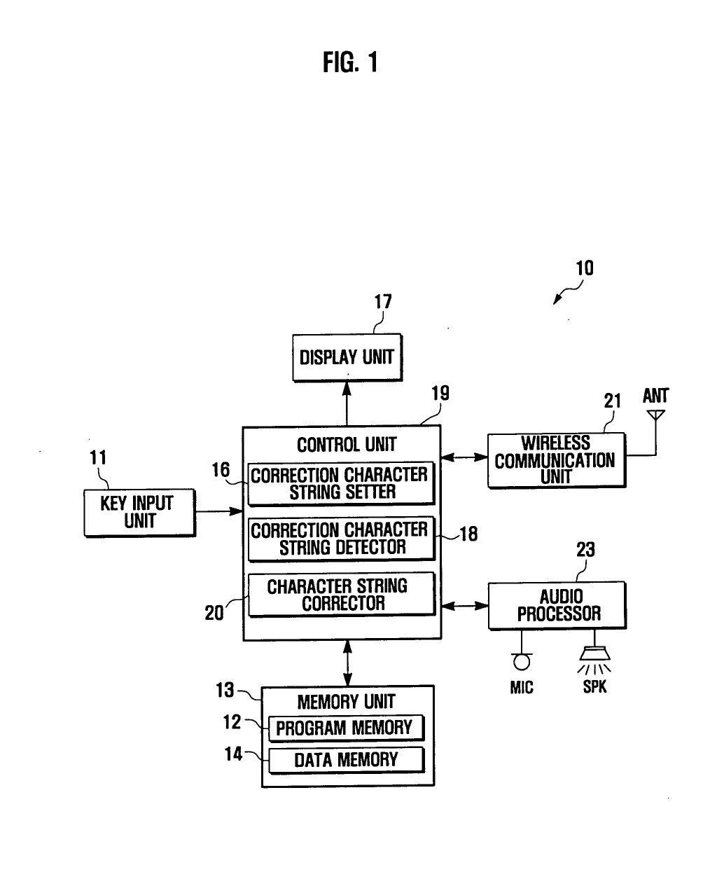

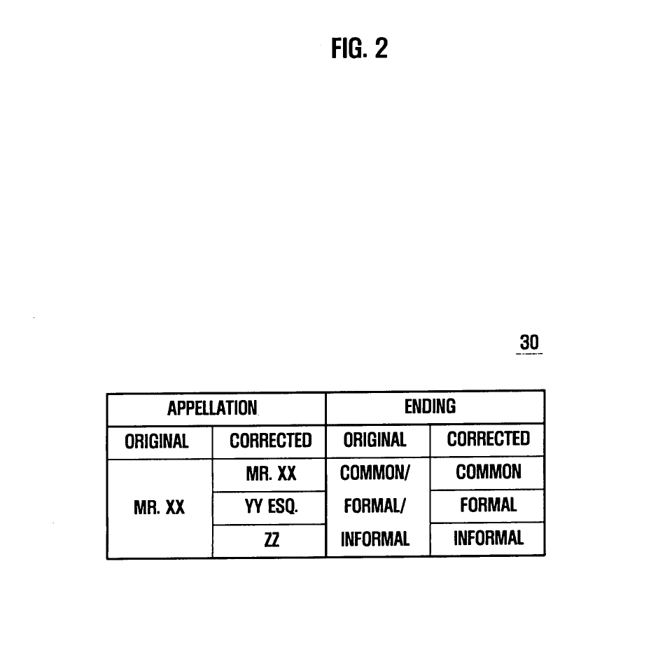

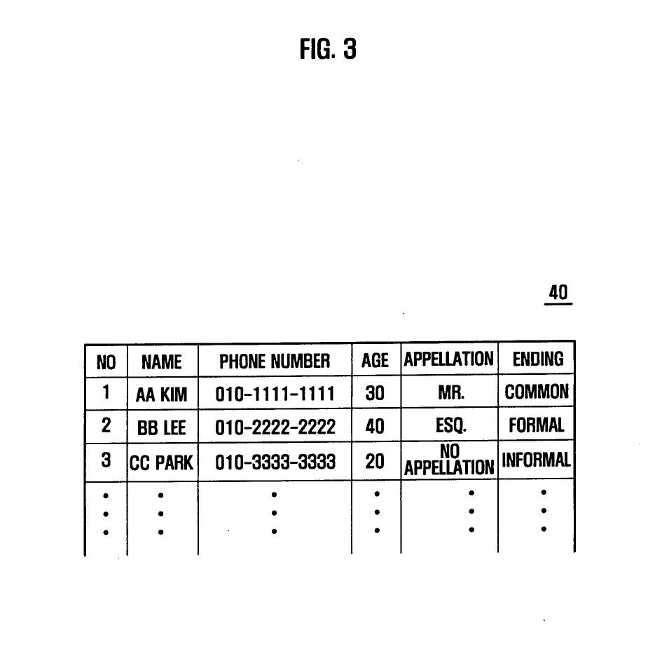

FIG. 1 is a block diagram illustrating a configuration of a mobile terminal 10 according to the present invention. FIG. 2 is a diagram illustrating an example of correction character string data 30 stored in a memory unit 13 of FIG. 1. FIG. 3 is a diagram illustrating an example of an address book 40 stored in the memory unit 13.

Referring to FIGS. 1-3, the mobile terminal 10 includes a key input unit 11, the memory unit 13, a display unit 17, a control unit 19, a wireless communication unit 21, and an audio processor 23.

The key input unit 11 has a plurality of keys for manipulation of input to the mobile terminal 10. The key input unit 11 delivers selection information input in response to a user's key selection to the control unit 19.

The memory unit 13 includes a program memory 12 for storing program data for controlling the operation of the mobile terminal 10 and a data memory 14 for storing data generated during control operation by the control unit 19 or during the user's use of the mobile terminal 10. More specifically, the program memory 12 stores a correction character string setting program for setting original and correct character strings, a correction character string detection program for detecting the original character string from a short message, and a character string correction program for replacing the detected original character string with correct character strings. The data memory 14 stores the correction character string data 30 and the address book 40.

The display unit 17 displays various function menus executed on the mobile terminal 10 and data stored in the memory unit 13 on a screen as images. In particular, the display unit 17 displays images according to selection of keys by the key input unit 11 as well as images related to setting the original and correct character strings and sending a short message. The display unit 17 typically can be a liquid crystal display (LCD).

The control unit 19 performs the overall control operation of the mobile communication terminal 10. In particular, the control unit 19 controls operations of setting original and correct character strings and of generating and sending a corrected short message containing the correct character strings.

The wireless communication unit 21 transmits and receives data for wireless communication. More specifically, the wireless communication unit 21 modulates and upconverts a short message signal output from the control unit 19 and transmits the signal through an antenna ANT. The wireless communication unit 21 also receives a short message signal via the antenna ANT and downconverts and demodulates the short message signal before sending to the control unit 19.

The control unit 19 controls the audio processor 23 to digitalize an audio signal received via a microphone MIC, to demodulate audio data received from the wireless communication unit 21, and to output the demodulated audio data through a speaker SPK.

Referring to FIG. 2, the correction character string data 30 stored in the data memory 14 includes original and correct character strings. The original and correct character strings contain appellations and endings for different recipients.

Original character string is a character string in a short message that a caller inputs through input keys. The original character string contains an appellation and a predicate ending. Preferably, a character string containing flag characters is used as the original character string to reduce errors in a correction character string detection program and allow easy input. For example, flag characters ‘Mr.XX’, ‘**’, or ‘##’ may be used as the original character string for the appellation.

The correct character strings are substituted for the original character string in the short message to create corrected short messages. Each correct character string contains appellation and predicate ending according to attributes of each recipient.

For example, if the original character string for a recipient's appellation is set to ‘Mr. XX’, correct character strings for a recipient's appellation may be set to ‘Mr. XX’, ‘YY Esq.’, and ‘ZZ’. In this case, recipients' names are inserted into ‘XX’, ‘YY’, and ‘ZZ’. Original character strings for a predicate ending are expressed in ‘common’, ‘formal’, and ‘informal’ terms. A correct character string for the predicate ending may be determined according to the type of the correct character string for the recipient's appellation. For example, when the correct character string for the recipient's appellation is “Mr. XX”, the correct character string for the predicate ending is expressed in “common” terms. When the correct character string for the appellation is “YY Esq.”, the correct character string for the predicate ending is expressed in “formal” terms. When the correct character string for the appellation is “ZZ”, the correct character string for the predicate ending is expressed in “informal” terms. The correct character string for the predicate ending may have various other terms including abbreviations.

Referring to FIG. 3, the address book 40 stored in the data memory 14 has at least one entry for a recipient's address information that includes the recipient's attributes. The recipient's address information may include the recipient's name, phone number, attributes, and correct character string. For example, the recipient's address information may contain the recipient's name “AA KIM”, phone number “010-1111-1111”, age “30”, correct character string for appellation “Mr.”, and the terms in which the correct character string for predicate ending is expressed in “common terms”. FIG. 3 shows an example in which age is used as a recipient's attribute. The address book 40 may also include original character strings.

Referring to FIG. 1, the control unit 19 includes a correction character string setter 16, a correction character string detector 18, and a character string corrector 20. The correction character string setter 16 sets the original and correct character strings according to the recipients' attributes. The correction character string detector 18 detects the original character string from the input short message. The character string corrector 20 creates a corrected short message for each recipient by replacing the original character string detected by the correction character string detector 18 with correct character string according to the attributes of the recipient. The character string corrector 20 also transmits the corrected short messages to the wireless communication unit 21.

As described herein, the mobile terminal 10 of the present invention allows a caller to transmit a corrected short message to each recipient by correcting one short message, i.e. appellation and predicate ending, according to the recipient's attributes.

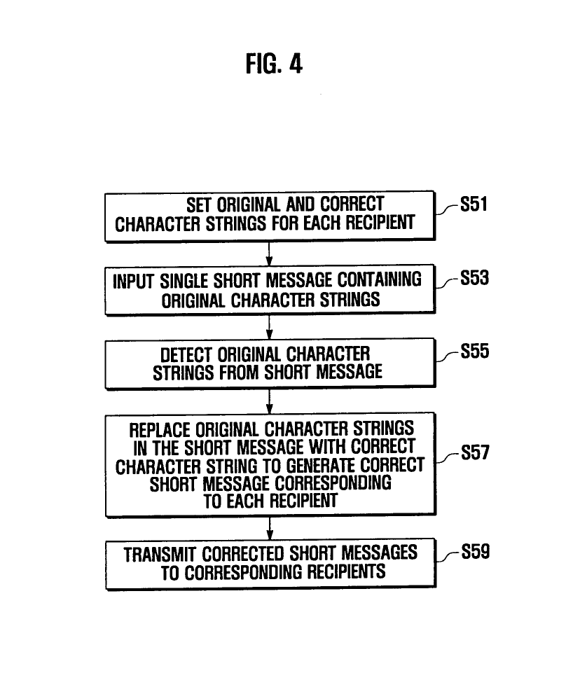

FIG. 4 is a flowchart illustrating a method for sending a short message on a mobile terminal according to the present invention. Referring to FIG. 4, the method includes setting original and correct character strings in step S51, inputting a short message in step S53, detecting the original character string in step S55, generating a corrected short message in step S57, and sending the corrected short message in step S59.

More specifically, original and correct character string is set in an address book for each recipient in step S51. One short message for the recipients containing the original character string is input in step S53. The original character string is detected from the short message in step S55, and for each recipient is replaced with the corresponding correct character string to generate a corrected short message for that recipient in step S57. The corrected short message is then sent to the corresponding recipient (S59).

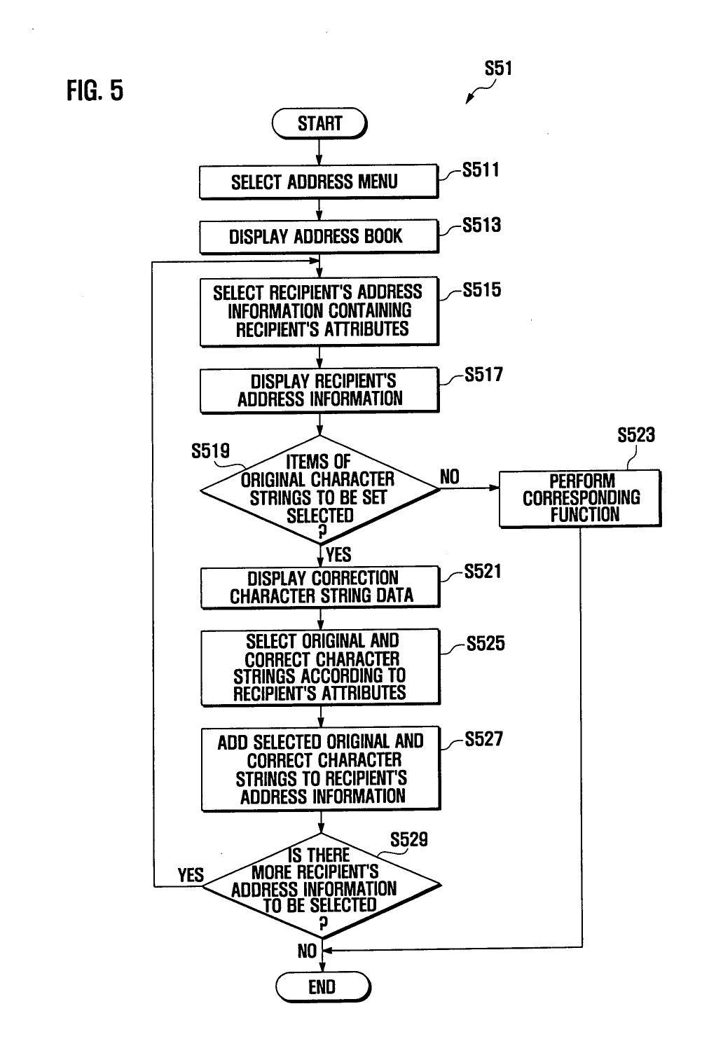

Step S51 of setting the original and correct character strings is described here with reference to FIGS. 1-5. FIG. 5 is a detailed flowchart illustrating the step of setting original and correct character strings in the method illustrated in FIG. 4.

Step S51 begins with selecting an address book menu from menus being displayed on a screen of the display unit 17 by a caller's key input through the key input unit 11 in step S511. The control unit 19 controls the display unit 17 to display an address book in step S513.

A recipient's address information for which original and correct character string will be set, containing recipient's attributes, is selected from the address book in step S515. The control unit 19 controls the display unit 17 to display the selected recipient's address information in step S517.

The control unit 19 determines whether items of original character string to be set (for example, appellation, predicate ending) have been selected from the recipient's address information in step S519. If items of original character strings have been selected, the control unit 19 controls the display unit 17 to display the correction character string data 30 in step S521. If items of original character strings have not been selected, a function corresponding to the other item is performed in step S523.

Original and correct character strings are selected from the correction character string data 30 (S525). That is, the correct character strings are selected from the correction character string data 30 through the caller's key input, based on the recipient's attributes contained in the recipient's address information. An appellation and a predicate ending contained in the short message are selected as the original character string. An appellation and a predicate ending to be used for a recipient are selected as the correct character string.

The correction character string setter 16 then adds the selected correct character string to the recipient's address information in step S527.

A message window is displayed asking the user whether there is more recipient's address information to be selected, and the control unit 19 determines a response through the caller's key input in step S529. If there is more recipient's address information to be selected, the process returns to step S515 of selecting the recipient's address information. If there is no more recipient's address information to be selected, the control unit 19 terminates the setting of the correct character strings.

Although, in the above description, the correct character strings are set based on correction character string data, the caller can directly set the correct character strings by inputting them through input keys.

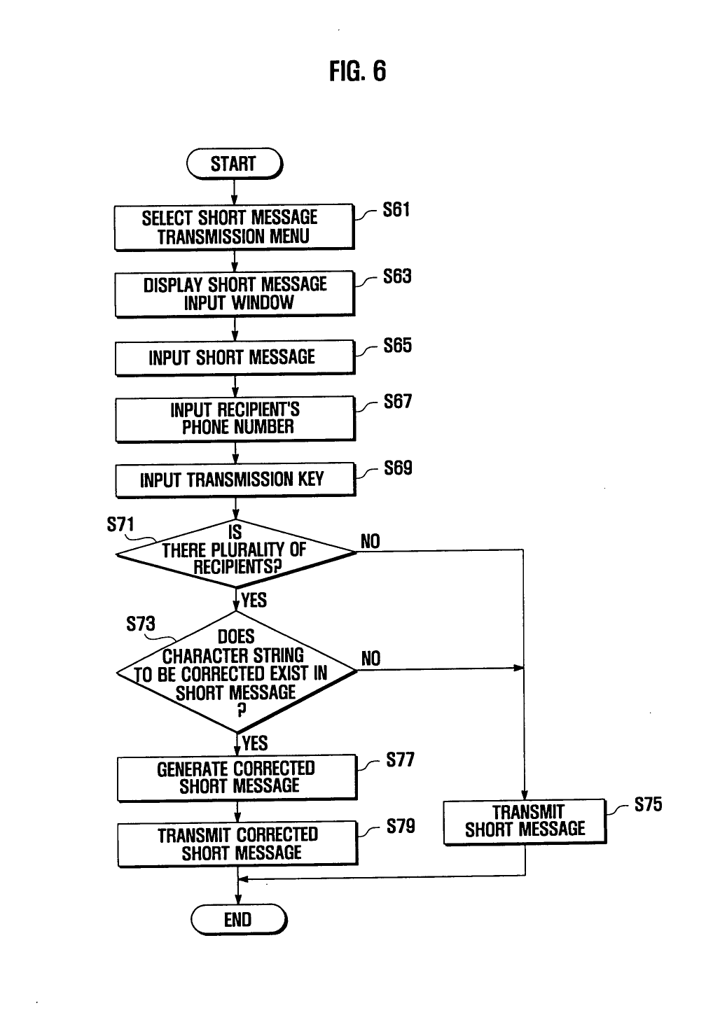

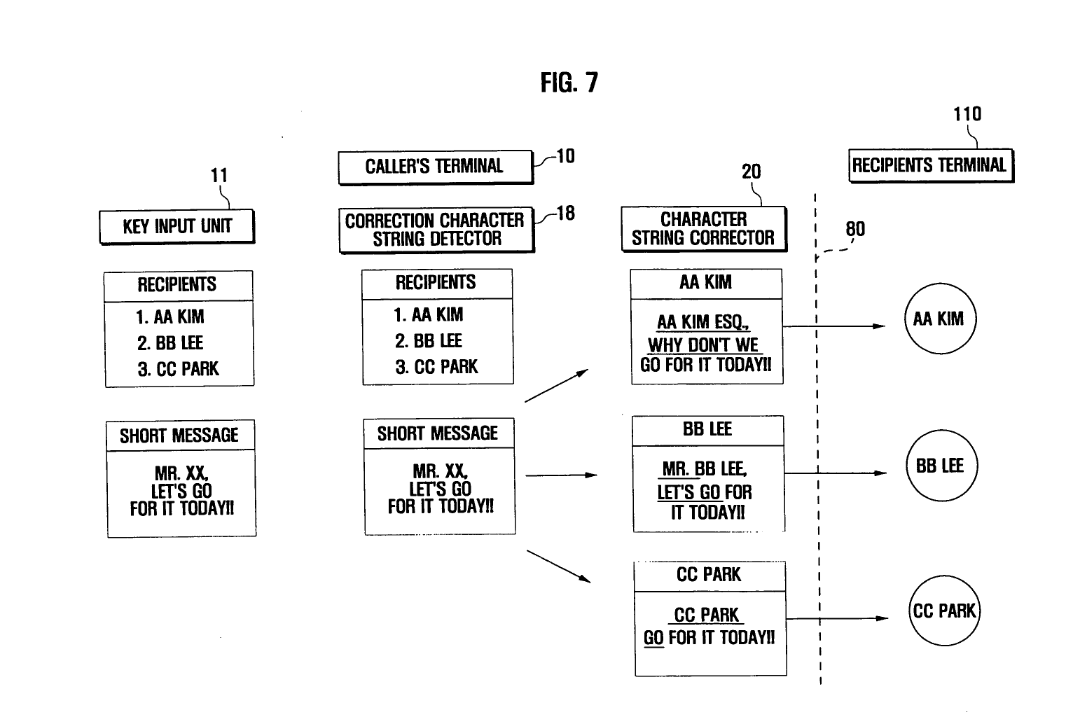

The step of correcting a short message generated by a caller and sending the corrected short message to each recipient is described as follows with reference to FIGS. 1, 6, and 7. FIG. 6 is a detailed flowchart illustrating the steps of inputting a short message and sending a corrected short message in the method illustrated in FIG. 4. FIG. 7 is a diagram illustrating an example of using a method for sending a short message on a mobile terminal according to the present invention.

First, a caller selects a short message transmission menu for sending a short message to a recipient's terminal 110 through input keys of the caller's terminal 10 in step S61. The control unit 19 controls the display unit 17 to display a short message input window on a screen in step S63.

A short message is input into the short message input window through keys in step S65. The short message may include original character string.

A recipient's phone number to which the short message will be sent is then input in step S67. The recipient's phone number may be input directly by the caller or by selecting from an address book.

Next, a short message transmission key is input in step S69. After the transmission key has been input, conventionally, the short message is usually sent through a wireless communication unit. However, in the present invention, the short message is corrected before transmission through the wireless communication unit 21.

More specifically, the control unit 19 determines whether there is a plurality of recipients in step S71, by checking whether a plurality of recipients’ phone numbers exists.

If there is a plurality of recipients, the correction character string detector 18 detects whether an original character string to be corrected exists in the short message in step S73.

For example, when the recipients are “AA KIM”, “BB LEE”, and “CC PARK” and the short message says “Mr. XX, let's go for it, today!!” as illustrated in FIG. 7, the correction character string detector 18 detects “Mr. XX” and “let's” as the original character string.

A corrected short message is then generated in step S77. That is, the character string corrector 20 for each recipient replaces the detected original character strings with correct character string to generate a corrected short message for that recipient.

Referring to FIG. 7, for example, when the recipient is “AA KIM”, the original character string “Mr.XX” is replaced with a correct character string “AA KIM Esq.”. The original character string “let's” is corrected into “why don't we”. Thus, a corrected short message to be sent to “AA KIM” is written in formal terms: “AA KIM Esq., why don't we go for it, today!!”. As another example, when a recipient is “BB LEE”, the corrected short message may be expressed in common terms: “Mr. BB LEE, let's go for it, today!!”. As another example, the corrected short message to be sent to “cc PARK” is expressed in informal terms: “Go for it today, CC PARK.”

A corrected short message for each recipient is sent by the control unit 19 to the recipient's terminal through the mobile communication network 80 in step S79.

If, in step S71, only a single recipient exists, or if, in step S73, an original character string to be corrected does not exist in the short message, the control unit 19 transmits the original input short message to all recipients through the mobile communication network 80 in step S75.

As described above, a mobile terminal and a method for sending a short message on the mobile terminal according to the present invention allow a caller to send a corrected short message to each recipient by correcting a single short message according to the recipient's attributes, thus reducing the number of short messages generated while increasing the recipient's satisfaction with a short message.

While the present invention has been particularly shown and described with reference to exemplary embodiments thereof, these embodiments are provided not to limit the scope of the invention, but to serve only for illustrative purposes. It will be understood by those of ordinary skill in the art that various changes in form and details may be made therein without departing from the spirit and scope of the present invention as defined by the following claims.

What is claimed is:

1. A method for sending a short message on a mobile terminal to recipients, comprising:
setting one or more original and correct character strings in an address book, each string corresponding to the recipients;
inputting one short message for transmission containing original character strings;
replacing the original character strings in the short message with correct character strings, each correct character string corresponding to the recipients, to generate corrected short messages, each corrected message corresponding to the recipients; and
sending the corrected short messages to the corresponding recipients.

2. The method of claim 1, wherein in the step of setting original and correct character string for each recipient, the original and correct character. string is set according to attributes of the recipient.

3. The method of claim 2, wherein setting original and correct character string for each recipient comprises:
selecting address information of the recipient containing the recipient's attributes from the address book;
setting the original and correct character string based on the recipient's attributes contained in the selected recipient's address information; and
adding the set original and correct character string to the selected recipient's address information.

4. The method of claim 2, wherein the attributes include at least one of the recipient's age, job title, group, and relationship to a caller.

5. The method of claim 4, wherein the correct character string includes an appellation and a predicate ending corresponding to the recipient.

6. The method of claim 5, wherein the original and correct character string is set by selecting from correction character string data.

7. The method of claim 5, wherein the original and correct character string is input directly by the caller.

8. The method of claim 2, wherein the original character string includes an appellation and a predicate ending that are contained in the short message.

9. The method of claim 1, wherein replacing the original character string with the correct character string to generate a corrected short message comprises:
detecting the original character string from the short message; and
replacing the original character string with the correct character string to generate a corrected short message for each recipient.

10. The method of claim 1, wherein setting original and correct character string in an address book corresponding to each recipient comprises:
selecting an address book menu;
selecting address information of the recipient containing attributes of the recipient from the address book menu;
selecting items of the original character string to be set from the recipient's address information and displaying correction character string data;
selecting original and correct character string from the correction character string data; and
adding the selected original and correct character string to the recipient's address information.

11. A method for sending a short message on a mobile terminal, comprising:
selecting a short message transmission menu;
inputting a short message for a recipient;
inputting a short message transmission key;
determining whether there is a plurality of recipients;
determining, if there is a plurality of recipients, whether a character string subject to correction according to attributes of the recipients exists within the short message;
correcting, if the character string subject to correction exists, the short message for each recipient; and
sending the corrected short messages to the corresponding recipients.

12. The method of claim 11, further comprising sending, if only one recipient exists, the short message to the recipient.

13. The method of claim 11, further comprising sending, if the character string subject to correction does not exist, the short message to the recipients.

14. A method for sending a short message on a mobile terminal, comprising:
inputting one short message for recipients;
detecting an appellation and a predicate ending subject to correction according to attributes of each of the recipients from the short message;
correcting for each recipient the short message by replacing the detected appellation and predicate ending with a new appellation and predicative ending according to attributes of that recipient; and
sending corrected short messages to the corresponding recipients.

15. The method of claim 14, wherein the recipient's attributes include at least one of the recipient's age, job title, group, and relationship to a caller.

16. A mobile terminal comprising:
a memory unit for storing an address book containing original and correct character strings set according to recipients' attributes;
a key input unit for inputting a short message for the recipients containing an original character string;
a correction character string detector for detecting the original character string from the short message;
a character string corrector for correcting the short message by replacing the original character strings in the short message with correct character strings, each correct character string corresponding to the recipients, to generate short messages, each corrected short message corresponding to the recipients; and
a wireless communication unit for receiving the corrected short messages from the character string corrector and sending the corrected short messages to the corresponding recipients.

17. The mobile terminal of claim 16, further comprising a correction character string setter for setting the original and correct character strings through a key input by the key input unit and adding the set original and correct character strings to the address book stored in the memory unit.

18. The mobile terminal of claim 17, wherein the address book includes at least one entry representing a recipient's address information including at least one of the recipient's name, phone number, attributes, and corrected character strings.

19. The mobile terminal of claim 18, wherein the attributes include at least one of the recipient's age, job title, group, and relationship to a caller.
